(19) United States
(12) Patent Application Publication
(10) Pub. No.: US 2016/0124611 A1
(43) Pub. Date: May 5, 2016

(54) NON-HIERARCHIAL INPUT DATA DRIVENDYNAMIC NAVIGATION

(71) Applicant: General Electric Company, Schenectady, NY (US)

(72) Inventors: Blaine Madison Mucklow, IV, San Ramon, CA (US); Thomas Macari, San Ramon, CA (US); Jacob Bassett, San Ramon, CA (US)

(21) Appl. No.: 14/530,421

(22) Filed: Oct. 31, 2014

(51) Int. Cl. G06F 3/0484; H04L 29/06; G06F 3/0481

(52) U.S. Cl. CPC G06F 3/04842; G06F 3/0481; H04L 67/42

(57) ABSTRACT

A method, system, and non-transitory computer-readable medium, the method including receiving a request for information related to a subject topic; presenting a user interface element representation of an first decision point associated with the subject topic in a first user interface display pane and a second user interface pane containing a user interface element representation of a plurality of user-selectable inputs corresponding to the first decision point; receiving an indication of a user's selection of one of the plurality of user-selectable inputs; automatically updating the first user interface pane to include a user interface element representation of a segment of information points related to the user's selection of one of the plurality of user-selectable inputs, a last information point included in the segment being a second decision point associated with the subject topic in an instance the segment includes a decision point.

### BACKGROUND

Navigation of a large amount of data in a user interface may be a tedious undertaking. The task of navigating the data may be made tedious, and in some instances unwieldy, by the sheer amount of data that may be included at any one time in the user interface. In some instances, the user interface may present many data items to a user in a user interface, to an extent that the user may have to scroll or otherwise navigate to a portion of the data in the UI that extends beyond the field of view of the user's display and/or be overwhelmed by the amount of data items in the user interface. In some instances, the data items may be arranged and presented in the user interface in a manner that makes navigating through and amongst the data items laborious. Such data item arrangements include but are not limited to a flat list, as is known in the field of user interfaces.

### SUMMARY

In some embodiments, a method includes receiving, by a processor, a request for information related to a subject topic; presenting, in a user interface, a user interface element representation of an first decision point associated with the subject topic in a first user interface display pane and a second user interface pane containing a user interface element representation of a plurality of user-selectable inputs corresponding to the first decision point associated with the subject topic; receiving, by the processor, an indication of a user's selection of one of the plurality of user-selectable inputs corresponding to the first decision point associated with the subject topic; updating, automatically by the processor, the first user interface pane to include a user interface element representation of a segment of one or more information points related to the user's selection of one of the plurality of user-selectable inputs, a last information point included in the segment being a second decision point associated with the subject topic in an instance the segment includes a decision point; and presenting the user interface including the updated first user interface pane.

In some embodiments, a non-transitory computer-readable medium includes instructions to receive a request for information related to a subject topic; instructions to present in a user interface, a user interface element representation of an first decision point associated with the subject topic in a first user interface display pane and a second user interface pane containing a user interface element representation of a plurality of user-selectable inputs corresponding to the first decision point associated with the subject topic; instructions to receive an indication of a user's selection of one of the plurality of user-selectable inputs corresponding to the first decision point associated with the subject topic; instructions to update, automatically, the first user interface pane to include a user interface element representation of a segment of one or more information points related to the user's selection of one of the plurality of user-selectable inputs, a last information point included in the segment being a second decision point associated with the subject topic in an instance the segment includes a decision point; and instructions to present the user interface including the updated first user interface pane.

In some embodiments, a system includes a storage device; a processor in communication with the storage device and operable to receive a request for information related to a subject topic; present, in a user interface, a user interface element representation of an first decision point associated with the subject topic in a first user interface display pane and a second user interface pane containing a user interface element representation of a plurality of user-selectable inputs corresponding to the first decision point associated with the subject topic; receive an indication of a user's selection of one of the plurality of user-selectable inputs corresponding to the first decision point associated with the subject topic; update, automatically, the first user interface pane to include a user interface element representation of a segment of one or more information points related to the user's selection of one of the plurality of user-selectable inputs, a last information point included in the segment being a second decision point associated with the subject topic in an instance the segment includes a decision point; and present the user interface including the updated first user interface pane.

### BRIEF DESCRIPTION OF THE DRAWINGS

FIG. 1 is an illustrative user interface, according to some embodiments;

FIG. 2 is an illustrative user interface, according to some embodiments;

FIG. 3 is an illustrative user interface depicting some aspects herein, according to some embodiments;

FIG. 4 is an illustrative user interface depicting some aspects herein, according to some embodiments;

FIG. 5 is an illustrative user interface depicting some aspects herein, according to some embodiments;

FIG. 6 is an illustrative flow diagram of a process, according to some embodiments;

FIG. 7 is an illustrative flow diagram of another process, according to some embodiments;

FIG. 8 is an illustrative flow diagram of yet another process, according to some embodiments;

FIG. 9 is a block diagram of a system, according to some embodiments; and

FIG. 10 is a depiction of an apparatus, in accordance with some embodiments herein.

### DESCRIPTION

Some embodiments herein relate to a method and system for providing non-hierarchical input data driven dynamic navigation. In some aspects, the non-hierarchical input data driven dynamic navigation herein may be embodied in a graphical user interface (also referred to as user interface). The graphical user interface may be displayed on any display device now known or that becomes known. In some aspects, a display device in accordance with aspects herein may include, be associated with, or connected to a system or device to receive input from a user. In some aspects, a user may interactively engage with the display (e.g., a touch-sensitive display device) and/or the system or device in communication the display to provide an indication of an user-selected input to the display and/or associated system or device.

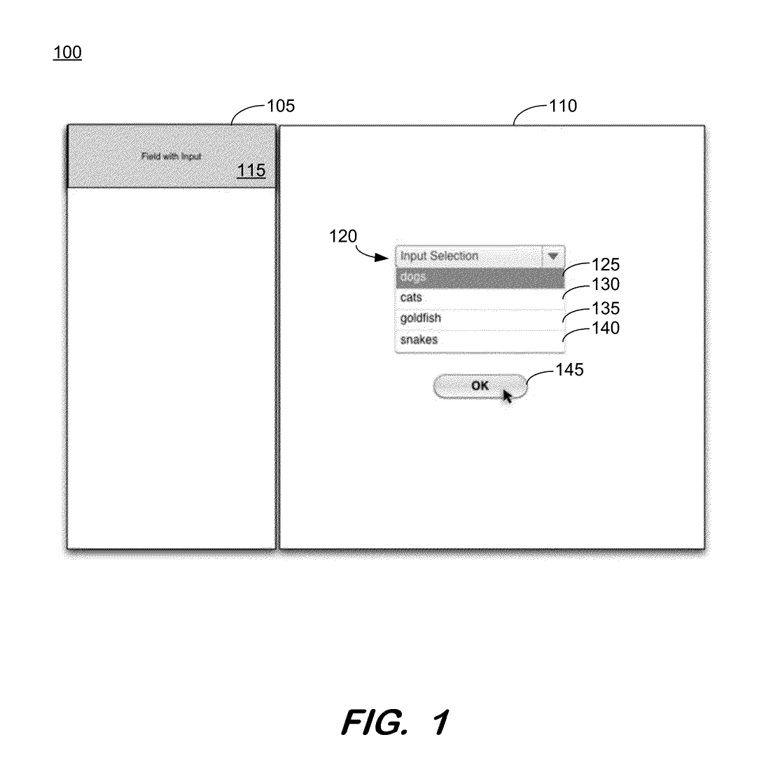

FIG. 1 is an illustrative depiction of a user interface (UI) 100, according to some embodiments herein. UI 100 may generally represent a user interface in accordance with some embodiments herein. UI 100 includes, in general, a first UI display pane 105 and a second UI display pane 110. First UI display pane 105 is shown to the left of simultaneously displayed second UI display pane 110 in FIG. 1. However, the particular arrangement of various aspects of UI 100, including the configuration of the first and second display panes 105 and 110 may be changed or altered from the specific configuration of FIG. 1 within the scope of the present disclosure.

First UI display pane 105 may include a user interface element representation of a first decision point 115 associated with a subject topic. The subject topic may be specified by a user prior to a displaying or generation of UI 100. The subject topic may relate to, for example, a workflow for diagnosing a problem related to a device or system, where the system may include a machine, a software application, a biological system, and other systems without limit herein. The subject topic may comprise other types of workflows or inter-related data sets. In accordance with some embodiments herein. In some embodiments, the subject topic may be set to a default value. In some embodiments, the subject topic may be set to a default value that is the only value for the subject topic in a particular embodiment. For example, an embodiment may specifically relate to only one subject topic where, in some aspects, the subject topic relates to such topics as a power plant.

First decision point 115 associated with a subject topic (as specified by, for example, a user) may have one or more user-selectable inputs 125, 130, 135, and 140 that relate to and correspond to first decision point 115. In the example of FIG. 1, a user interface element representation 120 includes the plurality of user-selectable inputs 125, 130, 135, and 140 that relate to first decision point 115.

In the example UI 100, the user interface element representation shown in first UI display pane 105 is a decision point. A decision point herein refers to an information point that has one or more user-selectable choices or options associated therewith. As used herein, an information point may or may not have a one or more user-selectable choices or options associated with it. A decision point is thus a specific type of information point herein, it is an information point that has one or more user-selectable choices or options associated therewith.

Referring still to FIG. 1, a user may select one of the plurality of user-selectable inputs 125, 130, 135, and 140 corresponding to first decision point 115. The selection may be effectuated by a user performing by one or more selecting methods compatible with UI 100. In one embodiment, the user may “click” on user-selectable input 125 and further “click” on user interface element confirmation button 145, “double click” on user-selectable input 125, or “long-press” on user-selectable input 125. Other input methods for 120 can also be used, such as free-form text entry, radio dialogs, yes/no and true/false selections, voice/speech input, and combinations thereof.

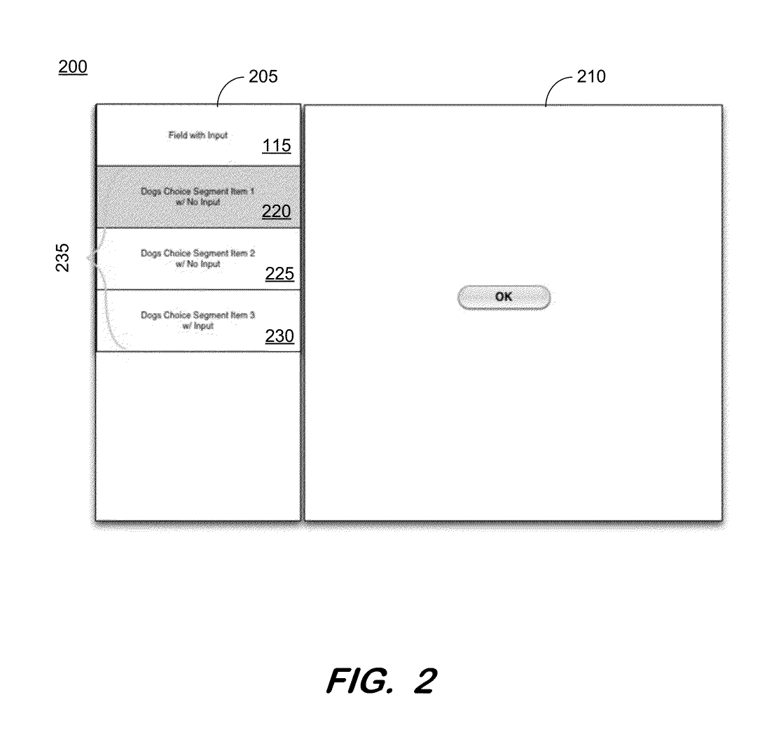

In response to selection of user-selectable input 125, UI 100 may transform to UI 200 of FIG. 2. UI 200 includes a first UI display pane 205 comprising first decision point 115. First UI display pane 205 further includes a user interface representation of a segment 235 including a plurality of information points 220, 225, and 230. In some instances, segment 235 may include one information point. The information points of segment 235 include one decision point 230. That is, information point 230 is a particular type, namely it is a decision point.

In some regards, the information points in first UI pane (105, 205) may constitute a workflow related to the subject topic. First UI display pane (105, 205) is populated with information points to the extent that a user has selected user-selectable inputs in the second UI display pane (110, 210) associated with the subject topic. For example, first decision point 115 has a plurality of associated user-selectable inputs 125, 130, 135, and 140. Until a user selects one of the plurality of user-selectable inputs 125, 130, 135, and 140, first UI display pane 105 only includes decision point 115. In response to a user selecting one of the plurality of user-selectable inputs 125, 130, 135, and 140 (e.g., 125), the first UI display pane is dynamically updated to include segment 235 as shown in FIG. 2 at 205.

In some embodiments, the first UI display pane is automatically updated to include segment 235 in response to the user selecting one of the plurality of user-selectable inputs 125, 130, 135, and 140 associated with the first decision point 115 of FIG. 1. The updating happens automatically by a system or device implementing the actions depicted in FIGS. 1 and 2. The updating is said to be dynamic since the segment (e.g., 235) and the information points comprising the segment (e.g., 220, 225, and 235) are not strictly static or fixed in presentation but instead their presentation depends on the particular one of the user-selectable inputs selected by a user.

In some embodiments, the information points in the first UI display pane herein may be navigated by a user. For example, a user may select one of the information points 220, 225, and 230 in segment 235 of FIG. 2. Information point 220 is shown as being selected in FIG. 2, as illustrated by the highlighting thereof. In some aspects, selecting an information point (e.g., 220) in first UI display pane 205 may invoke the display or presentation of information related to or corresponding to the selected information point in the second UI display pane 210. In some aspects, the displayed or otherwise presented information may be in the form of an audio presentation, a textual presentation, a pictorial presentation, a video presentation, a graphical presentation, a multimedia presentation, and combinations thereof. In some aspects, selection of an information point in the first UI display pane 205 may automatically cause the presentation of the related information in the second UI display pane 210.

In some aspects, a user may navigate to any one of the information points displayed in the first UI display pane 205. Navigation need not proceed in a strictly sequential manner (e.g., 220 to 225 to 230). Navigation may, for example, move from information point 220 to information point 230 and then back to information point 220 or 225, as determined by a user's control of the selection of the information points. As the user navigates through the information points in segment 235 by selecting the different information points 220, 225, and 230 therein, a display or presentation of information related to or corresponding to the selected information point may, in response, be displayed in second UI display pane 210.

In some embodiments, a last information point in a segment in the first UI display pane may be a decision point, in the instance the segment includes a decision point. That is, a segment may not include a decision point but if it does, then the decision point will be the last information point in the segment. The last information point in a segment, if any, is a decision point because further information points associated with the subject topic are determined based on and in response to a user-selected input and until such a user input selection is made to determine which related information points will be further listed in the first UI display pane, the last information point in the first UI display pane is the decision point. In some embodiments, the last information point in the first UI display pane 205 may be an information point in the instance that the segment does not include a decision point.

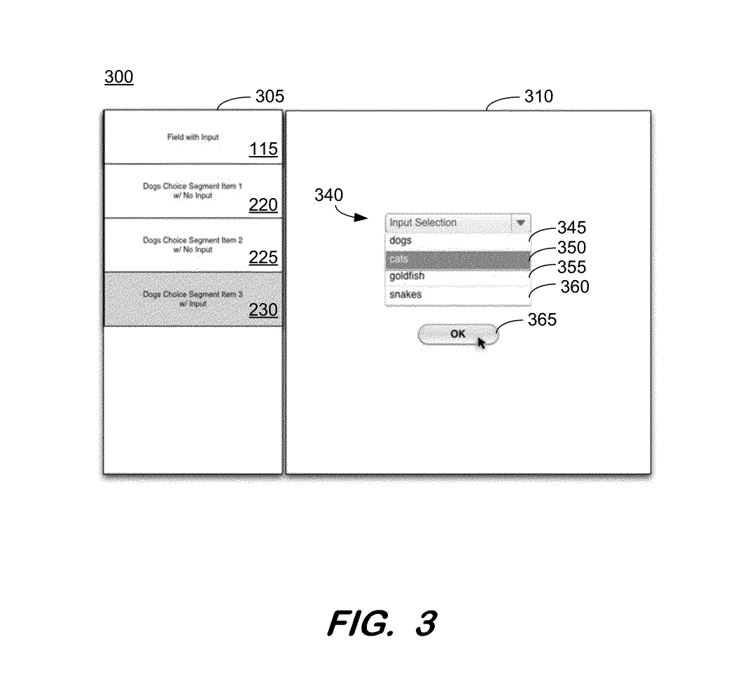

FIG. 3 is an illustrative depiction of a UI 300 herein, according to some embodiments. UI 300 may be presented on a display in response to a user navigating to information point 230 of FIG. 2. As shown in FIG. 3, information point 230 is highlighted, indicating that a user has navigated to this information point. In the example of FIGS. 2 and 3, information point 230 is a decision point. Information point 230 is the second decision point in the example including FIGS. 1, 2, and 3. Decision point 230 is associated with the subject topic and may have one or more user-selectable inputs 345, 350, 355, and 360 that relate to and correspond to the second decision point 230. In response to the user navigating to decision point 230, a user interface element representation 340 is automatically displayed in second UI display pane 310. User interface element representation 340 includes a plurality of user-selectable inputs 345, 350, 355, and 360 that relate to second decision point 230.

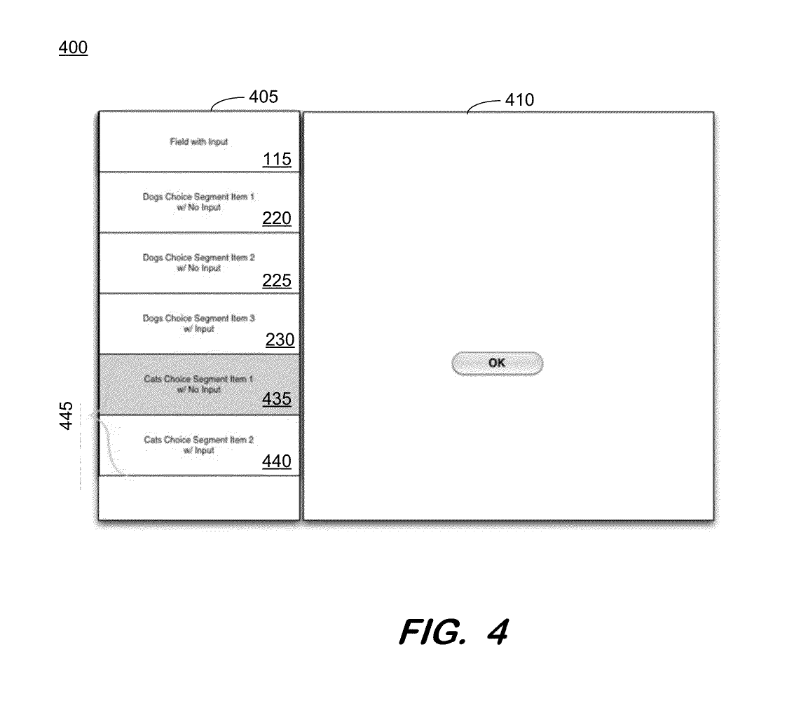

Referring to FIG. 3, a user may select one of the one or more user-selectable inputs 345, 350, 355, and 360 corresponding to second decision point 230. The user may select, for example, user-selectable input 350 (i.e., “cats”) as shown in FIG. 3. In response to selection of user-selectable input 350, UI 300 may be automatically updated and dynamically transformed to UI 400 of FIG. 4. UI 400 includes a first UI display pane 405 comprising information points 115 (i.e., the first decision point), 220, 225, 230 (i.e., the second decision point), 435, and 440. Information points 435 and 440 are included in a user interface representation of a segment 445. Segment 445 includes the plurality of information points 435 and 440. In some instances, segment 445 may include one information point. The information points in segment 445 may include one decision point. If segment 445 does include a decision point, then the last information point in segment 445 (i.e., information point 440) would be a decision point.

In some embodiments a user may, after having made decision point and user-selectable input selections such as those discussed by example above, navigate back to an earlier presented decision point. Referring to FIG. 4, a user may navigate back to decision point 230 from, for example, information point 435. In response to navigating back to and selecting (e.g., highlighting or otherwise indicating a selection) decision point 230, the user may again be presented with the user interface element representation 340 of FIG. 3 that includes the plurality of user-selectable inputs 345, 350, 355, and 360 relating to second decision point 230. In the instance the user selects an input other than the previously selected input 350 (e.g., input 355), then the information point(s) presented in the first interface pane 305 in a segment below decision point 230 (e.g., FIG. 4, segment 445) will be updated or changed to reflect the information point(s) specifically corresponding to the new user-selected input.

Referring to FIGS. 1-4, it is noted that some embodiments herein may include one or more segments in a first UI display pane, where the segments may include one or more information points and the last information point in a segment may be a decision point. The example(s) of FIGS. 1-4 show a last information point in a segment being a bottom-most information point in the segments (e.g., segments 235, 445). However, in other or alternate configurations of a first UI display pane, the “last” information point may be displayed as an upper-most information point in a bottom-up listing (not shown), a left-most information point in a right-to-left listing (not shown), a right-most information point in a left-to right listing (not shown), and other positions in other arrangements. Other such segment configurations may include, for example, a “circular” arrangement of information points in a segment (not shown).

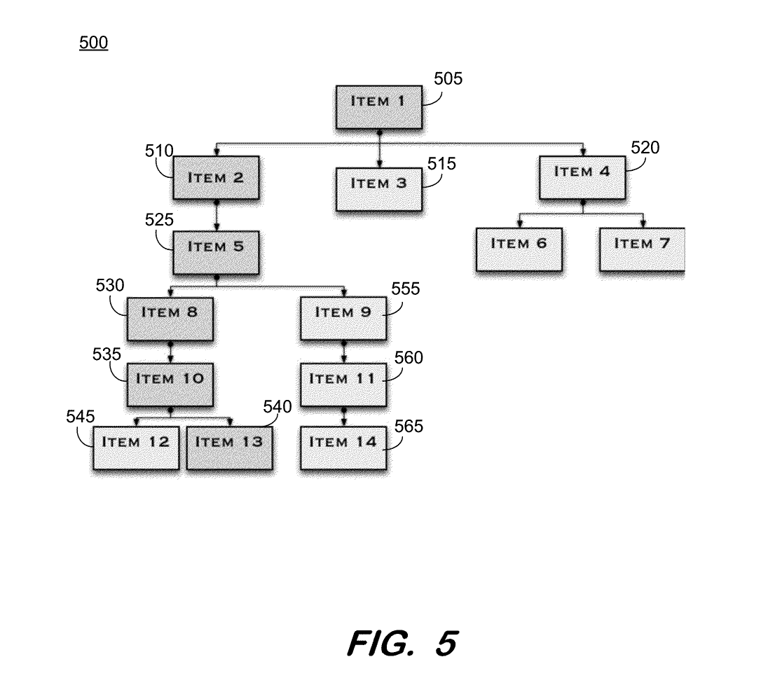

FIG. 5 is an illustrative data-based workflow 500, according to some embodiments. Workflow 500 is a simplified example of a set of data including a plurality of information points. FIG. 500 may be a logical representation of the data comprising the data set and the relationships between the information points or nodes of data therein. The data may be organized according to any number of different schemas in a variety of different embodiments including, for example a relational database, an object-orientated database, an in-memory database, etc. Referring to FIG. 5, workflow 500 includes a plurality of nodes representative of information points herein. Workflow 500 includes information points depicted as nodes 505, 510, 515, 520, 525, 530, 535, and 540 (as well as other information points not explicitly labeled with a reference number). Each node may be embodied as a data structure. In some embodiments, workflow 500 may include hundreds or thousands of information points.

In accordance with some embodiments herein, node 505 may be a first decision point associated with a subject topic and have information points 510, 515, and 520 associated therewith. Selection of a particular user-selectable input by a user in a UI herein may invoke the automatic display of a segment including nodes 510 and 525. Node 510 may be a “pass-through” information point and node 525 may be a decision point type of information point. Selection of a particular user-selectable input by a user in a UI herein may further invoke the automatic display of a segment including nodes 530 and 535, whereas a selection of another user-selectable input by a user when presented with decision point 525 in the UI may invoke the automatic display of a segment including nodes 555, 560, and 565. Node 530 may be a pass-through information point (i.e., not a decision point) and node 535 may be another decision point where selection of a particular user-selectable input by a user in a UI herein may invoke the updating of the UI to present information point 540 (or 545).

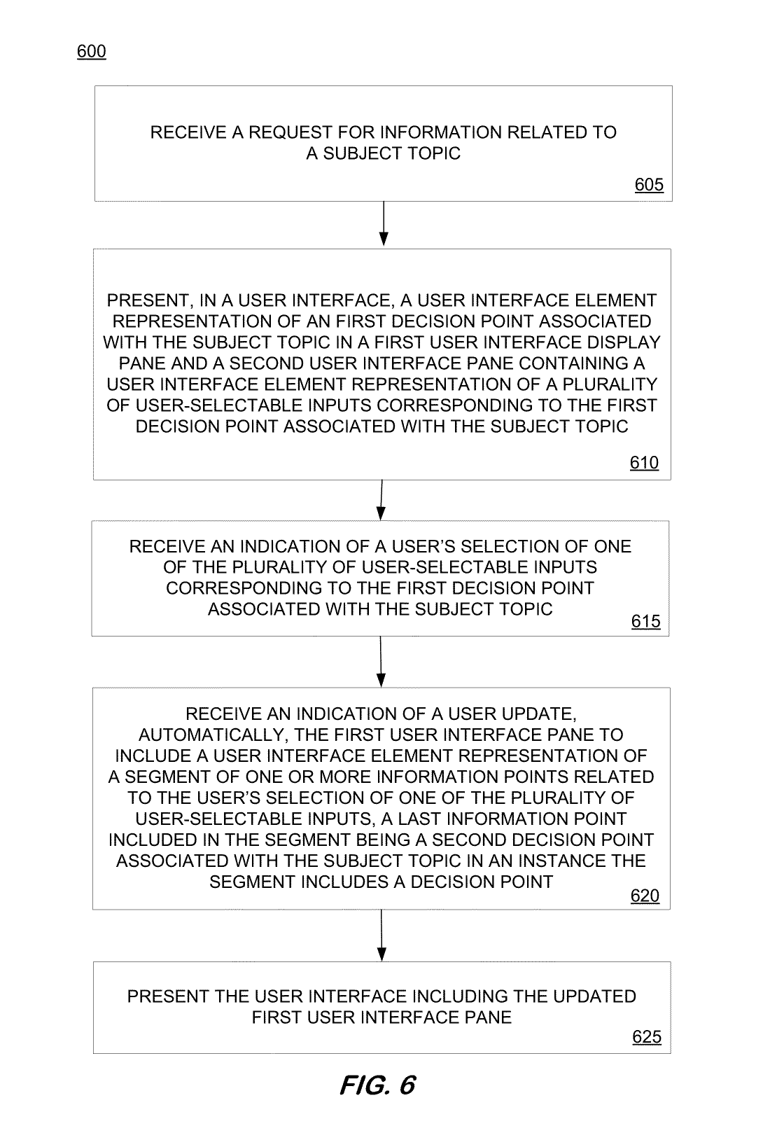

FIG. 6 is an illustrative flow diagram 600, in accordance with some embodiments herein. Operation 605 may include receiving a request for information related to a subject topic. The subject topic may be specified by a user or other mechanism, prior to operation 605, as indicated by the arrow leading into operation 605. In some embodiments, designation of the subject topic may be set to a default value and in some instances there may only be one possible subject topic in some embodiments.

Operation 610 may include presenting, in a user interface (e.g., 100), a user interface element representation of a first decision point (e.g., 115) associated with the subject topic in a first UI display pane (e.g., 105) and a second UI display pane (e.g., 110) containing a user interface element representation (e.g., 120) of a plurality of user-selectable inputs (e.g., 125, 130, 135, and 140) corresponding to the first decision point associated with the subject topic.

Process 600 may proceed to operation 615 in response to and based on a user input. In particular, operation 615 includes the actions of receiving an indication of a user's selection of one of the plurality of user-selectable inputs corresponding to the first decision point associated with the subject topic. The user's input may be indicated by the reception of a signal, a command, a message, and combinations thereof.

Operation 620 includes updating, automatically, the first user interface display pane (e.g., 205) to include a user interface element representation of a segment (e.g., 235) of one or more information points (e.g., 220, 225, and 230) related to the user's selection of one of the plurality of user-selectable inputs (e.g., 125). In some embodiments, a last information point (e.g., 230) included in the segment may be a second decision point associated with the subject topic in an instance the segment includes a decision point (FIG. 3, decision point 230).

Process 600 may further include an operation 625 where the UI including the updated first user interface pane of operation 620 (e.g., UI display pane 205) is presented for display.

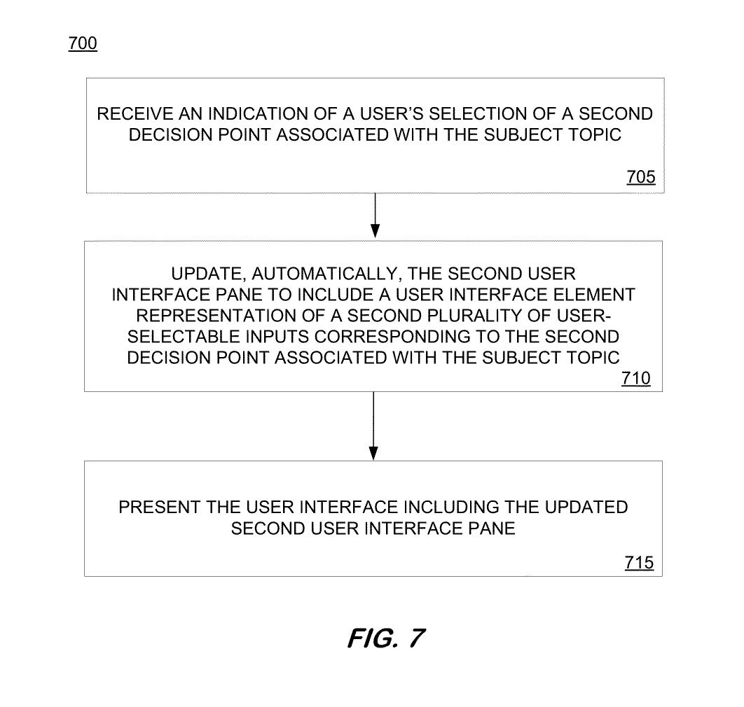

FIG. 7 is an illustrative flow diagram of another process 700, according to some embodiments. Process 700 may comprise a portion of another process. Hence, the arrows leading into and out of process 700. Operation 705 may include receiving an indication of a user's selection of a second decision point (e.g., FIG. 3, decision point 230) associated with the subject topic. The reception of the indication of the user's selection of the second decision point may operate to cause the updating, automatically, of the second user interface pane (e.g., 310) to include a user interface element representation (e.g., 340) of a second plurality of user-selectable inputs (e.g., 345, 350, 355, and 360) corresponding to the second decision point associated with the subject topic. Process 700 may proceed to operation 715 that includes presenting the UI including the updated second user interface pane of operation 710 is presented for display.

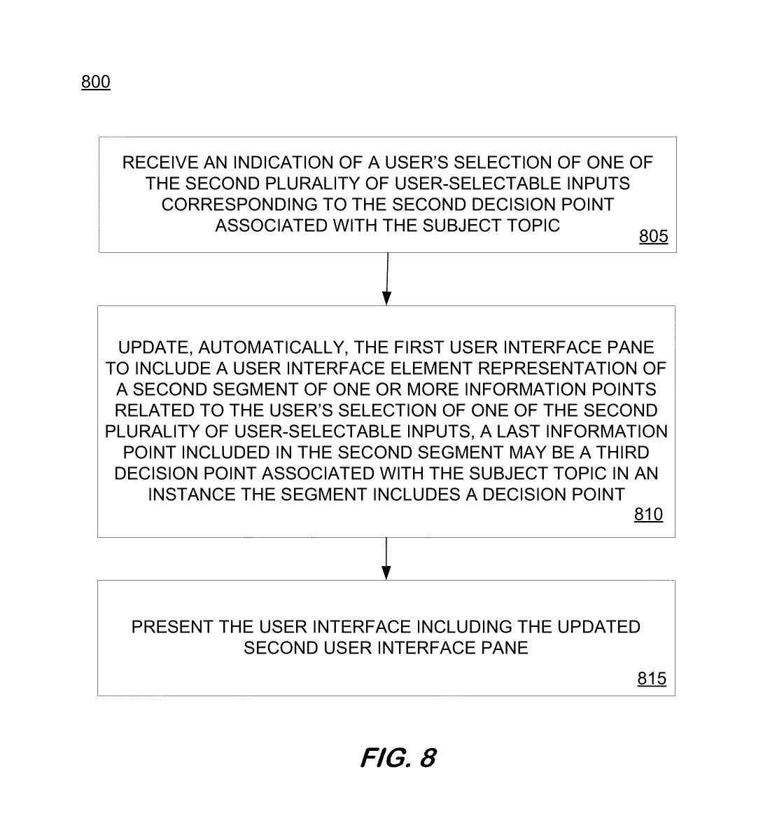

FIG. 8 is an illustrative flow diagram of another process 800, according to some embodiments. Process 800 may comprise a portion of another process. In some embodiments, process 800 may encompass or include at least some of the aspects of UI 300 and UI 400. Operation 805 may include receiving an indication of a user's selection of one (e.g., FIG. 3, 350) of the second plurality of user-selectable inputs corresponding to the second decision point (e.g., FIG. 3, 230) associated with the subject topic.

Process 800 may proceed from operation 805 to operation 810 that includes updating, automatically, the first user interface pane (e.g., FIG. 4, 405) to include a user interface element representation of a second segment (e.g., FIG. 4, 445) of one or more information points (e.g., FIGS. 4, 435 and 440) related to the user's selection of one (e.g., FIG. 3, 350) of the second plurality of user-selectable inputs. A last information point included in the second segment may be a third decision point (e.g., FIG. 4, 440) associated with the subject topic in an instance the segment includes a decision point. Process 800 may proceed to operation 815 that includes presenting the UI (e.g., FIG. 4, 400) including the updated first UI display pane of operation 810 for display purposes.

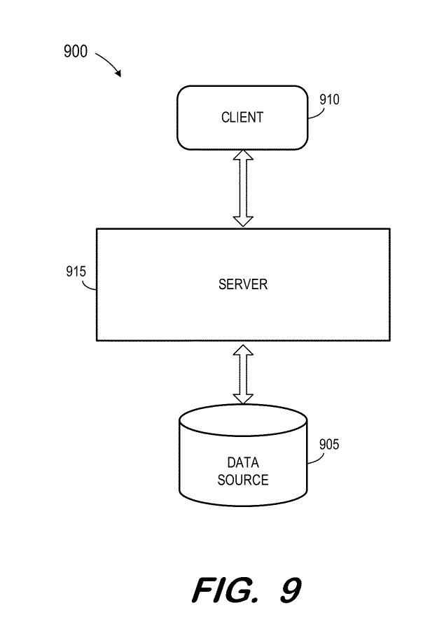

FIG. 9 is a block diagram of a system 900, according to some embodiments. System 900 is an example of a system compatible with some embodiments and aspects herein. In some embodiments, a system implementation of various aspects of the present disclosure may have more, fewer, and alternative components and systems to those depicted in FIG. 9. System 900 may include a data source 905. Data source may be a database system, a data store of any type and configuration, and a data or service provider. Data source 905 may include the data that supports and backs up the data sets, information points, and decision points disclosed herein. A server 915 may communicate with data source 905, either directly or indirectly sing a wired or wireless communication channel and any type of communication protocol herein without limits. Server 915 may, in some instances, be an application server where it serves applications that embody and implement one or more of the processes disclosed herein. System 900 may further include a client device 910. In some embodiments, client 910 may be a personal computer; a mobile computing device such as, for example, a smartphone and a computing tablet; and other devices generally having a processor, a display, and a memory that are enabled to execute some embodiments of some of the processes disclosed herein.

In some embodiments, application of “app” may be deployed to a device at client 900. In some embodiments, the information to be presented in a second UI display pane in conjunction with the different information points navigated by a user herein may be deployed with the app and stored or persisted in a memory (not shown) associated with client 910. The particular information points (e.g., steps of a workflow) and the relationships therebetween may be stored @ server 915 or a data store accessible by server 915.

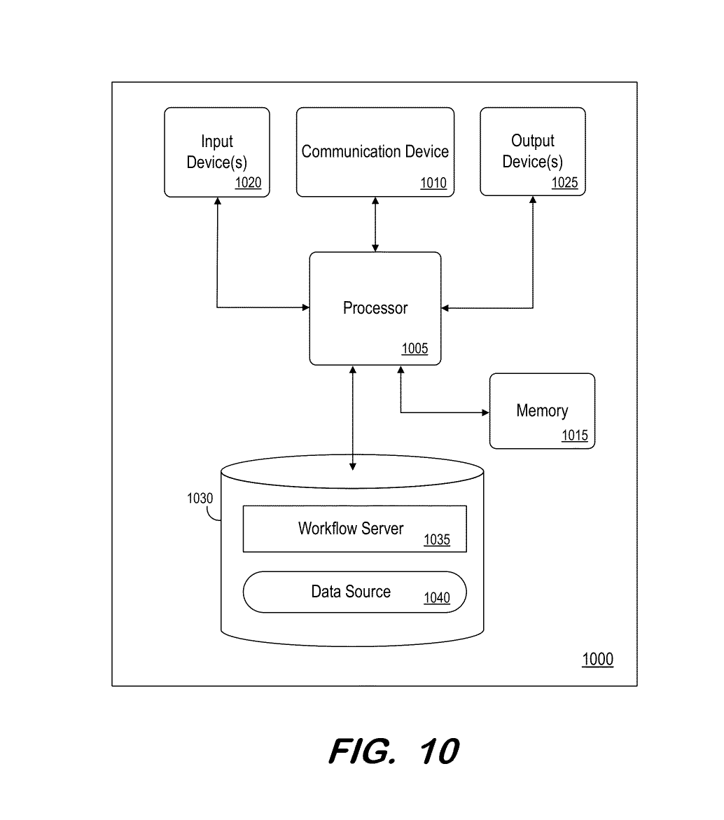

FIG. 10 is a block diagram of apparatus 1000 according to some embodiments. Apparatus 1000 may comprise a general-purpose computing apparatus and may execute program code or instructions to perform any of the processes described herein. Apparatus 1000 may comprise an implementation of server 915comprising, for example, an in-memory database. Apparatus 1000 may include other unshown elements according to some embodiments.

Apparatus 1000 includes processor 1005 operatively coupled to communication device 1010, data storage device 1030, one or more input devices 1020, one or more output devices 1025 and memory 1015. Communication device 1010 may facilitate wired or wireless communication with external devices, such as a client device (e.g., 910) or a data storage device. Input device(s) 1020 may comprise, for example, a keyboard, a keypad, a mouse or other pointing device, a microphone, a knob or a switch, an infra-red (IR) port, a docking station, and/or a touch screen. Input device(s) 1020 may be used, for example, to enter information into apparatus 1000. Output device(s) 1025 may comprise, for example, a display (e.g., a display screen), a speaker, and/or a printer.

Data storage device 1030 may comprise any appropriate persistent storage device, including combinations of solid state storage devices, magnetic storage devices (e.g., magnetic tape, hard disk drives and flash memory), optical storage devices, Read Only Memory (ROM) devices, etc., while memory 1015 may comprise Random Access Memory (RAM).

Server 1035 may comprise program code or instructions executed by processor 1005 to cause apparatus 1000 to perform any one or more processes disclosed herein. Embodiments are not limited to execution of such processes by a single apparatus. Data source 1040 may store data structure representations of the information points herein, as described above. Data source 1040 may be implemented in volatile memory. Data storage device 1030 may also store data and other program code for providing additional functionality and/or which are necessary for operation of apparatus 1000, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 900 and/or the UI's of FIGS. 1-4 may include a processor to execute program instructions such that the computing device operates as described herein.

All processes disclosed herein may be embodied in processor-executable program instructions read from one or more of non-transitory computer-readable media, such as a solid state storage device, a removable disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations.

What is claimed is:

1. A computer-implemented method, the method comprising:
receiving, by a processor, a request for information related to a subject topic;
presenting, in a user interface, a user interface element representation of an first decision point associated with the subject topic in a first user interface display pane and a second user interface pane containing a user interface element representation of a plurality of user-selectable inputs corresponding to the first decision point associated with the subject topic;
receiving, by the processor, an indication of a user's selection of one of the plurality of user-selectable inputs corresponding to the first decision point associated with the subject topic;
updating, automatically by the processor, the first user interface pane to include a user interface element representation of a segment of one or more information points related to the user's selection of one of the plurality of user-selectable inputs, a last information point included in the segment being a second decision point associated with the subject topic in an instance the segment includes a decision point; and
presenting the user interface including the updated first user interface pane.

2. The method of claim 1, wherein the first user interface pane and the second user interface pane are simultaneously presented in the user interface.

3. The method of claim 1, wherein a selection of one of the information points in the segment invokes a presentation of information related to the selected information point.

4. The method of claim 3, wherein the presentation of information may include at least one of a text presentation, a graphical presentation, a textual presentation, an audio presentation, a video presentation, a multimedia presentation, and combinations thereof.

5. The method of claim 1, further comprising:
receiving, by the processor, an indication of a user's selection the second decision point associated with the subject topic;
updating, automatically by the processor, the second user interface pane to include a user interface element representation of a second plurality of user-selectable inputs corresponding to the second decision point associated with the subject topic; and
presenting the user interface including the updated second user interface pane.

6. The method of claim 5, further comprising:
receiving, by the processor, an indication of a user's selection of one of the second plurality of user-selectable inputs corresponding to the second decision point associated with the subject topic;
updating, automatically by the processor, the first user interface pane to include a user interface element representation of a second segment of one or more information points related to the user's selection of one of the second plurality of user-selectable inputs, a last information point included in the second segment being a third decision point associated with the subject topic in an instance the segment includes a decision point; and
presenting the user interface including the updated first interface pane.

7. A non-transitory computer-readable medium having executable instructions stored thereon, the medium comprising:
instructions to receive a request for information related to a subject topic;
instructions to present in a user interface, a user interface element representation of an first decision point associated with the subject topic in a first user interface display pane and a second user interface pane containing a user interface element representation of a plurality of user-selectable inputs corresponding to the first decision point associated with the subject topic;
instructions to receive an indication of a user's selection of one of the plurality of user-selectable inputs corresponding to the first decision point associated with the subject topic;
instructions to update, automatically, the first user interface pane to include a user interface element representation of a segment of one or more information points related to the user's selection of one of the plurality of user-selectable inputs, a last information point included in the segment being a second decision point associated with the subject topic in an instance the segment includes a decision point; and
instructions to present the user interface including the updated first user interface pane.

8. The medium of claim 7, wherein the first user interface pane and the second user interface pane are simultaneously presented in the user interface.

9. The medium of claim 7, wherein a selection of one of the information points in the segment invokes a presentation of information related to the selected information point.

10. The medium of claim 9, wherein the presentation of information may include at least one of a text presentation, a graphical presentation, a textual presentation, an audio presentation, a video presentation, a multimedia presentation, and combinations thereof.

11. The medium of claim 7, further comprising:
instructions to receive an indication of a user's selection the second decision point associated with the subject topic;
instructions to update, automatically, the second user interface pane to include a user interface element representation of a second plurality of user-selectable inputs corresponding to the second decision point associated with the subject topic; and
instructions to present the user interface including the updated second user interface pane.

12. The medium of claim 11, further comprising:
instructions to receive an indication of a user's selection of one of the second plurality of user-selectable inputs corresponding to the second decision point associated with the subject topic;
instructions to update, automatically, the first user interface pane to include a user interface element representation of a second segment of one or more information points related to the user's selection of one of the second plurality of user-selectable inputs, a last information point included in the second segment being a third decision point associated with the subject topic in an instance the segment includes a decision point; and
instructions to present the user interface including the updated first interface pane.

13. A system comprising:
a storage device;
a processor in communication with the storage device and operable to:
receive a request for information related to a subject topic;
present, in a user interface, a user interface element representation of an first decision point associated with the subject topic in a first user interface display pane and a second user interface pane containing a user interface element representation of a plurality of user-selectable inputs corresponding to the first decision point associated with the subject topic;
receive an indication of a user's selection of one of the plurality of user-selectable inputs corresponding to the first decision point associated with the subject topic;
update, automatically, the first user interface pane to include a user interface element representation of a segment of one or more information points related to the user's selection of one of the plurality of user-selectable inputs, a last information point included in the segment being a second decision point associated with the subject topic in an instance the segment includes a decision point; and
present the user interface including the updated first user interface pane.

14. The system of claim 13, wherein the first user interface pane and the second user interface pane are simultaneously presented in the user interface.

15. The system of claim 13, wherein a selection of one of the information points in the segment invokes a presentation of information related to the selected information point.

16. The system of claim 15, wherein the presentation of information may include at least one of a text presentation, a graphical presentation, a textual presentation, an audio presentation, a video presentation, a multimedia presentation, and combinations thereof.

17. The system of claim 13, further comprising the processor being enabled to:
receive an indication of a user's selection the second decision point associated with the subject topic;
update, automatically, the second user interface pane to include a user interface element representation of a second plurality of user-selectable inputs corresponding to the second decision point associated with the subject topic; and
present the user interface including the updated second user interface pane.

18. The system of claim 17, further comprising the processor being enabled to:
receive an indication of a user's selection of one of the second plurality of user-selectable inputs corresponding to the second decision point associated with the subject topic;
update, automatically, the first user interface pane to include a user interface element representation of a second segment of one or more information points related to the user's selection of one of the second plurality of user-selectable inputs, a last information point included in the second segment being a third decision point associated with the subject topic in an instance the segment includes a decision point; and
present the user interface including the updated first interface pane.
